(19) United States
(12) Patent Application Publication
(10) Pub. No.: US 2023/0347362 A1
(43) Pub. Date: Nov. 2, 2023

(54) FOAM SPRAYER

(71) Applicant: CANADIAN TIRE CORPORATION LIMITED, Toronto (CA)

(72) Inventors: Abdul Haleem Ahamed KOYA, Oakville (CA); Aras PUODZIUNAS, Toronto (CA); Edmond MONK, Scarborough (CA); John Paul SCHMIDER, Scarborough (CA); David GREEN, Toronto (CA)

(21) Appl. No.: 17/732,579

(22) Filed: Apr. 29, 2022

(51) Int. Cl. B05B 7/00; B05B 7/24; B05B 7/04

(52) U.S. Cl. CPC B05B 7/0031; B05B 7/2416; B05B 7/0483

(57) ABSTRACT

A sprayer has: a reservoir for containing a liquid to be sprayed; a compressor fluidly connected to the reservoir; a pressure sensor operatively connected to one or more of the compressor and the reservoir; and a controller operatively connected to the compressor and the pressure sensor, the controller comprising a processing unit and a computer-readable medium having instructions stored thereon executable by the processing unit for: receiving a signal from the pressure sensor, the signal indicative of a pressure inside the reservoir; comparing the pressure inside the reservoir to a first threshold; and when the pressure inside the reservoir is below the first threshold, actuating the compressor for pressurizing the reservoir until the pressure inside the reservoir reaches the first threshold.

### TECHNICAL FIELD

This disclosure generally relate to the field of cleaning devices and, more particularly, to the field of foam sprayers operable to mix air with a fluid to create a foam to be sprayed.

### BACKGROUND OF THE ART

Typically, foam sprayers include a reservoir containing a liquid to be sprayed. Pressure is increased within the reservoir to push the liquid out of the foam sprayer via a nozzle. In those devices, the pressure inside the reservoir is increased via a manual pump. Typically, the pressure decreases as the user sprays the foam. This decrease in pressure renders inconsistent a consistency of the foam. Such devices are cumbersome because the user needs to constantly manually pump air into the reservoir to continue using the device. Improvements are sought.

### SUMMARY

In one aspect, there is provided a sprayer comprising: a reservoir for containing a liquid to be sprayed; a compressor fluidly connected to the reservoir; a pressure sensor operatively connected to one or more of the compressor and the reservoir; and a controller operatively connected to the compressor and the pressure sensor, the controller comprising a processing unit and a computer-readable medium having instructions stored thereon executable by the processing unit for: receiving a signal from the pressure sensor, the signal indicative of a pressure inside the reservoir; comparing the pressure inside the reservoir to a first threshold; and when the pressure inside the reservoir is below the first threshold, actuating the compressor for pressurizing the reservoir until the pressure inside the reservoir reaches the first threshold.

The sprayer may include any of the following features, in any combinations,

In some embodiments, the instructions are executable for: determining that the liquid is being sprayed; comparing the pressure inside the reservoir to a second threshold lower than the first threshold; and when the pressure inside the reservoir is below the second threshold, actuating the compressor for re-pressurizing the reservoir until the pressure inside the reservoir is above the second threshold and corresponds to at most the first threshold.

In some embodiments, the instructions are executable for actuating of the compressor for re-pressurizing the reservoir comprising actuating the compressor until the pressure inside the reservoir reaches the first threshold.

In some embodiments, a trigger is engaged to a valve selectively opening and closing a reservoir outlet of the reservoir, the trigger having a first configuration in which fluid communication between the reservoir and an environment outside the reservoir is blocked by the valve and a second configuration in which the reservoir is open to the environment for outputting the liquid, wherein the instructions are executable for determining that the liquid is being sprayed comprising determining that the trigger is in the second configuration.

In some embodiments, the instructions are executable for determining that the liquid is being sprayed comprising determining that the pressure inside the reservoir is decreasing.

In some embodiments, a connector has a connector inlet fluidly connected to an outlet of a pump of the compressor, a first connector outlet fluidly connected to the pressure sensor, and a second connector outlet fluidly connected to the reservoir.

In some embodiments, the sprayer has: a conduit having a first end for outputting the liquid and a second end configured to be submerged in the liquid; and a mixer at the first end of the conduit, the mixer having a first mixer inlet fluidly connected to the first end of the conduit, a second mixer inlet in fluid flow communication with a volume of air inside the reservoir, and a mixer outlet for outputting a mixture of the air and the liquid from the reservoir.

In some embodiments, the sprayer has a battery operatively connected to the compressor.

In some embodiments, the sprayer has a control panel having: a button operable to switch the sprayer between an off configuration and an on configuration; and an indicator configured for outputting a first indication of the compressor being operational and for outputting a second indication when the pressure inside the reservoir reaches the first threshold.

In some embodiments, the compressor includes a piston pump.

In some embodiments, the reservoir is removably engageable to a body of the sprayer.

In another aspect, there is provided a method of operating a sprayer having a reservoir for containing a liquid to be sprayed and a compressor for pressurizing the reservoir, the method comprising: receiving a signal from a pressure sensor operatively connected to one or more of the reservoir and the compressor, the signal indicative of a pressure inside the reservoir; comparing the pressure inside the reservoir to a first threshold; and when the pressure inside the reservoir is below the first threshold, actuating the compressor for pressurizing the reservoir until the pressure inside the reservoir reaches the first threshold.

The method may include any of the following features, in any combinations:

In some embodiments, the method includes: determining that the sprayer is being used for spraying the liquid contained in the reservoir; comparing the pressure inside the reservoir to a second threshold lower than the first threshold; and when the pressure inside the reservoir is below the second threshold, actuating the compressor for re-pressurizing the reservoir until the pressure inside the reservoir is above the second threshold and corresponds to at most the first threshold.

In some embodiments, the actuating of the compressor for re-pressurizing the reservoir includes actuating the compressor until the pressure reaches inside the reservoir the first threshold.

In some embodiments, the sprayer comprises a trigger engaged to a valve selectively opening and closing a reservoir outlet of the reservoir, the trigger having a first configuration in which fluid communication between the reservoir and an environment outside the reservoir is blocked by the valve and a second configuration in which the reservoir is open to the environment for outputting the liquid, further wherein the determining that the sprayer is being used includes determining that the trigger is in the second configuration.

In some embodiments, the determining that the sprayer is being used includes determining that the pressure inside the reservoir is decreasing.

In some embodiments, the method includes: outputting a first indication of the compressor being operational; and outputting a second indication when the pressure inside the reservoir reaches the first threshold.

Many further features and combinations thereof concerning the present improvements will appear to those skilled in the art following a reading of the instant disclosure.

### DESCRIPTION OF THE DRAWINGS

FIG. 1 is a three dimensional view of the foam sprayer in accordance with one embodiment;

FIG. 2 is a three dimensional exploded view of the foam sprayer of FIG. 1;

FIG. 3 is a cross-sectional view of the foam sprayer of FIG. 1;

FIG. 3A is an enlarged view of a portion of FIG. 3 illustrating replacement tips of the foam sprayer of FIG. 1;

FIG. 4 is a three-dimensional exploded view of a compressor of the foam sprayer of FIG. 1;

FIG. 5 is a partially transparent three-dimensional view of a portion of the foam sprayer of FIG. 1;

FIG. 6 is a partially transparent cross-sectional view of a portion of the foam sprayer of FIG. 1;

FIG. 7 is an enlarged view of a portion of the foam sprayer of FIG. 1 illustrating a tip thereof;

FIG. 8 is a three dimensional view of the tip of FIG. 7;

FIGS. 9A and 9B are flowcharts illustrating steps of a method of operating the foam sprayer of FIG. 1; and

FIG. 10 is a schematic representation of a control system of the foam sprayer of FIG. 1.

### DETAILED DESCRIPTION

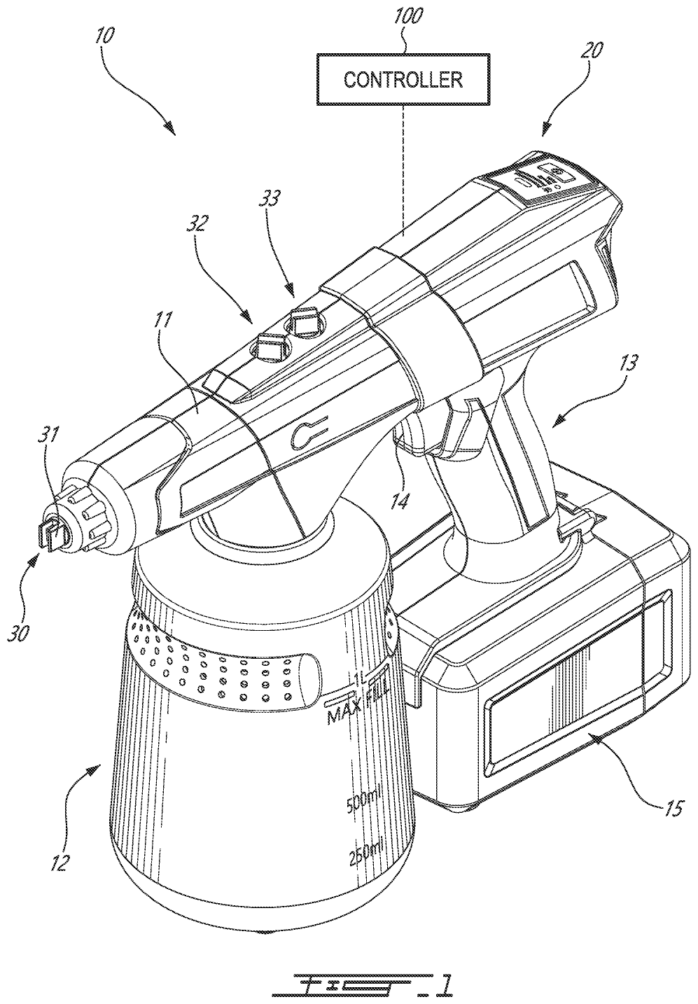

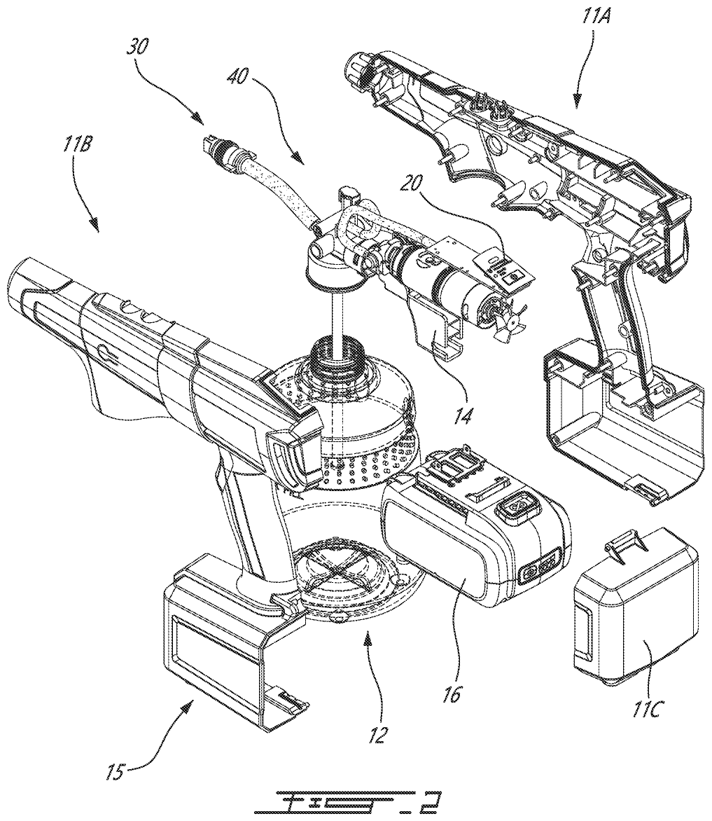

Referring to FIG. 1, a foam sprayer is shown generally at 10. The foam sprayer 10 has an outer shell or body 11 and a reservoir 12 removably secured to the outer shell 11. In the embodiment shown, the reservoir 12 is threadingly engageable to the outer shell 11. In this case, the outer shell 11 defines a threaded aperture to be threadingly engaged by a threaded collar of the reservoir 12. Other means of removably securing the reservoir 12 to the shell 11 are contemplated (e.g., keyway, dog and slots, etc). The reservoir 12 is used for containing a liquid to be sprayed. The outer shell 11 defines a handle 13 to be engaged by a hand of a user. A trigger 14 is movably engaged to the outer shell 11 and is engageable by a finger of the user for triggering the spraying of the liquid contained in the reservoir 12. The outer shell 11 includes a battery holder 15. The foam sprayer 10 includes a battery 16 (FIG. 2) removably secured to the outer shell 11 via the battery holder 15. A converter may be operatively connected to the battery 16. Any suitable battery may be used. The foam sprayer 10 includes a control panel 20 secured to the outer shell 11 and engageable by the user for powering on or powering off the foam sprayer 10. The control panel 20 is described further detail herein below.

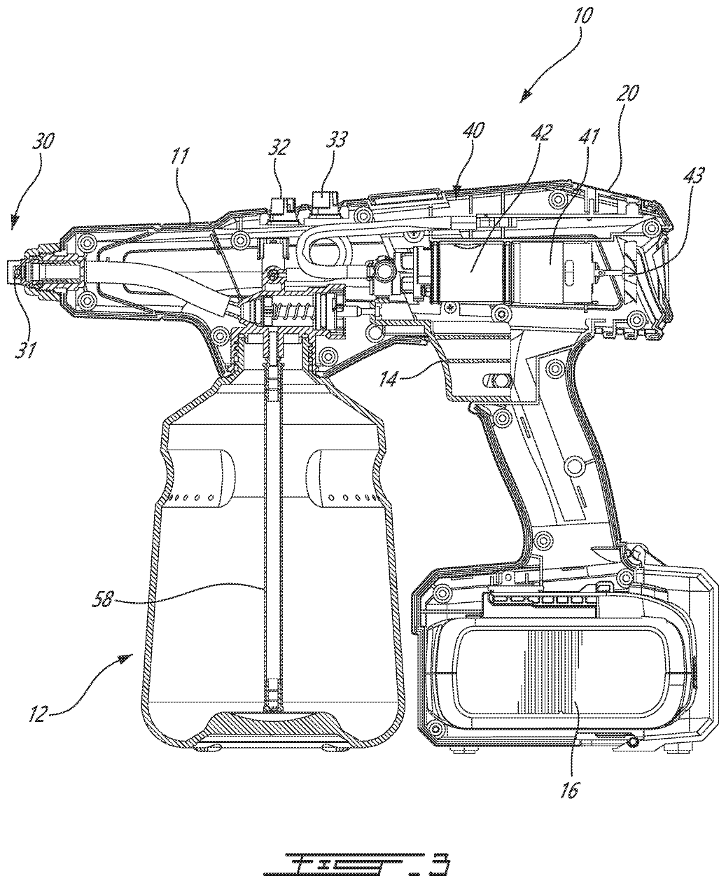

The foam sprayer 10 includes a nozzle 30 secured to the outer shell 11 and that is used for outputting a foam. In the embodiment shown, the nozzle 30 includes a tip 31 designed for outputting a foam at a 15° angle. Replacement tips 32, 33 may be removably secured to the shell 11 and may be substituted for the tip 31 that is currently secured at the outlet of the foam sprayer 10. These replacement tips 32, 33 may respectively be designed to output a foam at 25° and 40°. Other angles may be used. As shown in FIG. 3A, these tips 31, 32, 33 may be threaded to the outer shell 11 or secured to the outer shell 11 via any suitable connection such as, snap fit, dog and slot, keyway, etc. More specifically, the outer shell 11 may define one or more openings 110 for accepting the tips 32, 33.

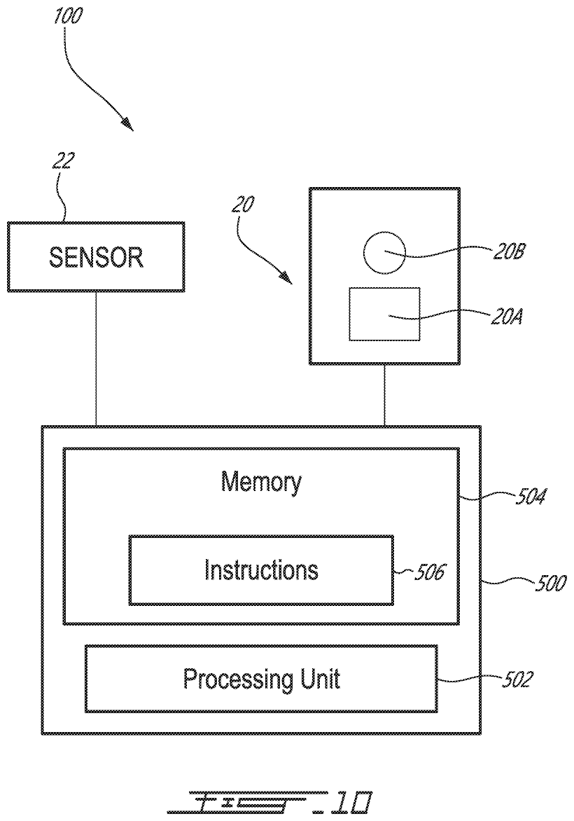

The foam sprayer 10 includes a controller 100 that is used for controlling operation of the foam sprayer 10. As will be discussed below, the controller 100 is operable for receiving signal(s) indicative of a pressure inside the reservoir 12 and for actuating a pump for increasing said pressure. The controller 100 is operatively connected to the control panel 20. More detail about the controller 100 is presented below with reference to FIG. 10.

Referring now to FIG. 2, the outer shell 11 includes two halves 11A, 11B that cooperate with each other to enclose a compressor module, or simply compressor 40 herein below, of the foam sprayer 10. The two halves 11A, 11B may be mirror images of one another and enclose a cavity sized to accept the compressor 40 and any other required components. For instance, the controller 100 may be contained within the cavity defined by the two halves 11A, 11B. The battery 16 may be removably enclosed within the outer shell 11. The battery holder 15 may include a removable cover 110 to enclose the battery 16 within the outer shell 11. Any other ways of securing the battery 16 may be used.

Referring now to FIG. 3, the compressor 40 is shown in greater detail. The compressor 40 is operable to increase an air pressure inside the reservoir 12 thereby forcing the liquid contained in the reservoir 12 to be outputted by the foam sprayer 10 via the nozzle 30. The compressor 40 includes a motor 41 operatively connected to the battery 16 and in driving engagement with a pump 42. The motor 41 drives the pump 42. The pump 42 has an inlet in fluid communication with an environment outside the reservoir 12 and an outlet in fluid flow communication with an inner volume of the reservoir 12 thereby increasing an air pressure inside the reservoir 12. A fan 43 may be drivingly engaged by the motor 41 to cool down the motor 41 during use.

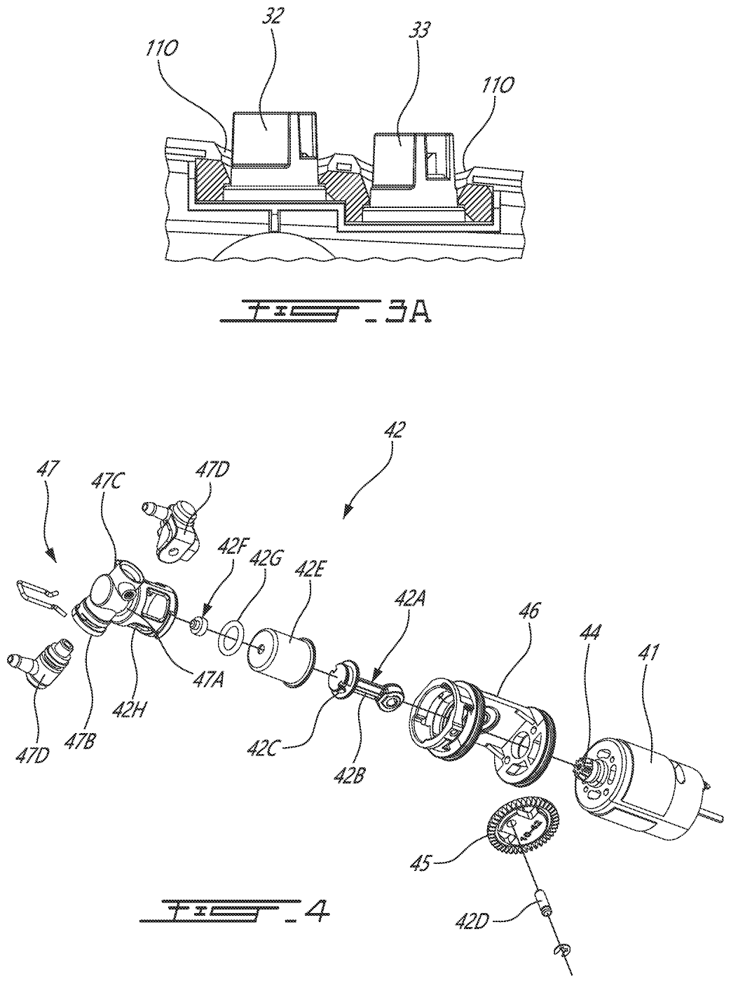

Referring now to FIG. 4, in the embodiment shown, the motor 41 is drivingly engaged to a first bevel gear 44, which is meshed with a second bevel gear 45. These two bevel gears 44, 45 rotate about axes that are perpendicular to one another. The pump 42 has a piston 42A having a rod 42B and a head 42C mounted to the rod 42B. The rod 42B is mounted on a pin 42D secured to the second bevel gear 45 for rotation therewith about a rotation axis of the second bevel gear 45. The pin 42D is offset from a center of the second bevel gear 45. The head 42C of the piston 42A rides within a cylinder 42E, which is received within a cylinder head 42H. A sealing engagement is provided between the cylinder 42E and the head 42C of the piston 42A. This sealing engagement may be provided by a sealing member 42G, such as an O-ring. Rotation of a shaft of the motor 41 induces rotation of the first bevel gear 44 and of the second bevel gear 45. Rotation of the second bevel gear 45 is translated in to a reciprocating motion of the piston 42A within the cylinder 42E thanks to the pin 42D and second bevel gear 45. A one-way or check valve 42F is in fluid communication with the cylinder 42E to allow air compressed by the piston 42A to exit the cylinder 42E. In the embodiment shown, the second bevel gear 45 is rollingly engaged to a housing 46. The piston 42A and cylinder 42E may be contained within the housing 46. Any suitable compressor or pump may be used. In some embodiments, a gear pump may be used. A fixed displacement pump may be used.

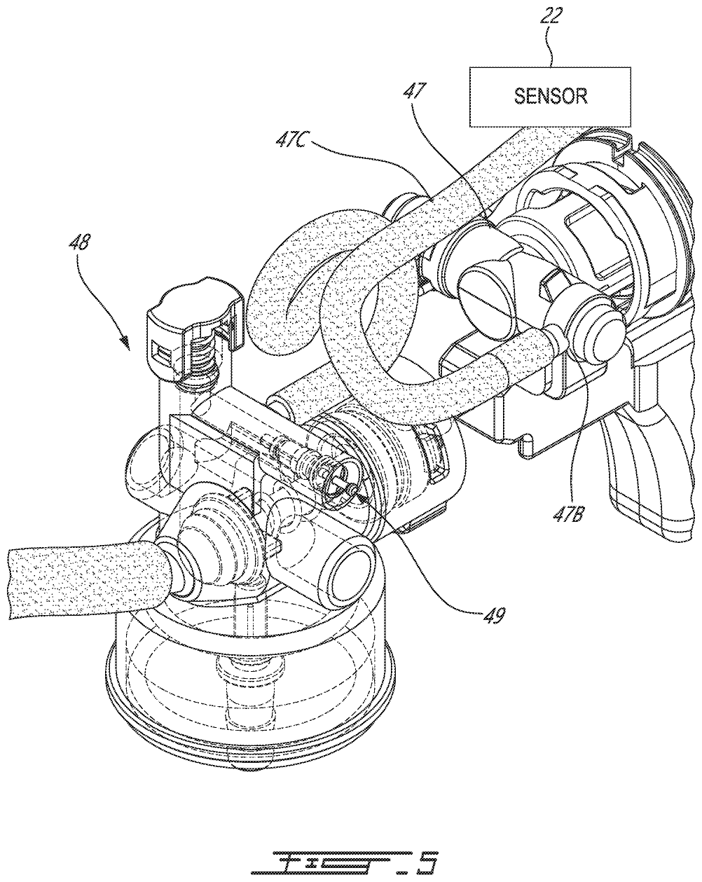

Referring to FIGS. 4 and 5, a connector 47 is mounted in fluid flow communication with an outlet of the one-way valve 42F. The connector 47 has a connector inlet 47A fluidly connected to the outlet of the one-way valve 42F, a first connector outlet 47B in fluid flow communication with a sensor 22, and a second connector outlet 47C in fluid flow communication with the reservoir 12 for directing the compressed air inside the reservoir 12. Suitable conduits may be used for flowing the air from the connector 47 to the sensor 22 and the reservoir 12. In the embodiment shown, rubber pipe connectors 47D are used as adaptors between the connector 47 conduits leading to the sensor 22 and the reservoir 12.

As shown in FIG. 5, the foam sprayer 10 may be equipped with a pressure regulating valve 48 in fluid communication with the reservoir 12 and used for automatically releasing pressure from the reservoir 12 when the pressure inside the reservoir 12 reaches a given threshold. This pressure regulating valve 48 is a safety device. The foam sprayer 10 may be further equipped with a manual valve 49 in fluid communication with the reservoir 12. The manual valve 49 may be engaged by the user for purging the reservoir 12 of the compressed air. This may be required for storage purposes and/or when it is time to refill the reservoir 12 with liquid (e.g., soap). Any suitable manual valve and pressure regulating valve known in the art may be used.

As shown in FIG. 5, the sensor 22 is in direct fluid communication with the compressor 40. In the present case, the sensor 22 is in direct fluid communication with the pump 42. This is provided by a conduit that fluidly directly connects the first connector outlet 47B to the sensor 22 independently of the reservoir 12. Another conduit directly fluidly connects the pump 42 to the reservoir via the second connector outlet 47C of the connector 47. In the embodiment shown, having the sensor 22 directly connected to the compressor 40, as opposed to directly connected to the reservoir 12, may avoid the fluid contained in the reservoir 12 from contacting the sensor 22 in a situation where the foam sprayer 10 is used upside down or tilted. Locating the sensor 22 as shown may also be more convenient since it is closer to the control panel. In another embodiment, if the sensor 22 is able to withstand contact with the fluid, a direct connection between the sensor 22 and the reservoir 12 is contemplated.

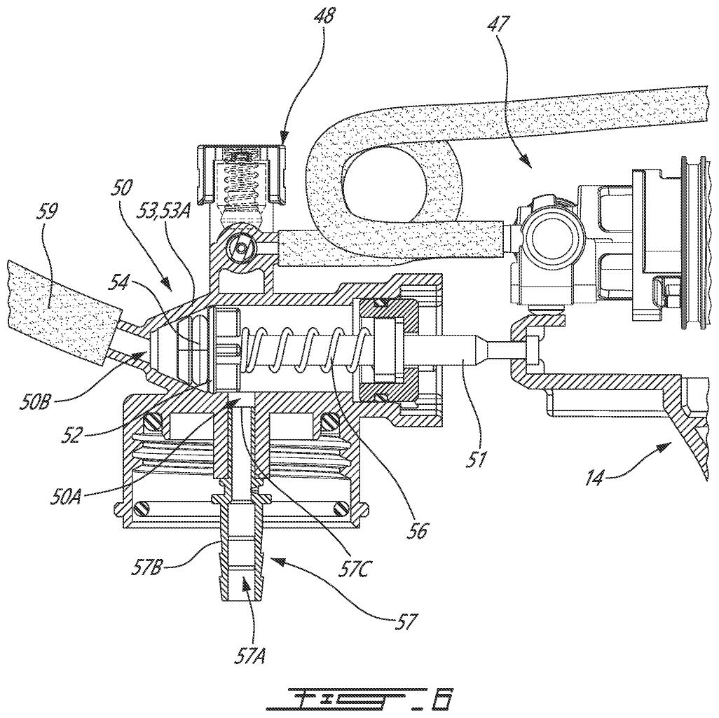

Referring now to FIG. 6, the foam sprayer 10 includes a valve 50 engaged by the trigger 14. The valve 50 has an inlet 50A fluidly connected to the reservoir 12 and an outlet 50B fluidly connected to the nozzle 30. The valve 50 includes a shank 51 engaged by the trigger 14. A valve body 52 is movably received within a valve housing 53. The valve body 52 has a first position depicted in FIG. 6 in which the valve body 52 sealingly engages a seat 53A defined by the valve housing 53 and a second position in which the valve body 52 is spaced apart from the seat 53A. In the embodiment shown, the valve body 52 and the valve housing 53 have frustoconical shapes. Any suitable valve may be used. Fluid communication between the reservoir 12 and the environment outside the reservoir 12 via the nozzle 30 is blocked by the valve 50 in the first position of the valve body 52 and allowed through the valve 50 with the valve body 52 in the second position. A sealing member 54 (e.g., O-ring) may be engaged to the valve body 52 for providing the sealing engagement with the seat 53A of the valve housing 53. A biasing member 56 may be engaged between the valve body 52 and the valve housing 53 and operable to bias the valve body 52 in the first position depicted in FIG. 6 and in which the valve body 52 sealingly engages the seat 53A to prevent the mixture contained in the reservoir 12 from flowing toward the nozzle 30.

Referring to FIGS. 3 and 6, the foam sprayer 10 includes a mixing rod 57 used for creating a mixture of the fluid contained in the reservoir 12 and air contained in the reservoir 12 above the fluid. The mixing rod 57 has a first inlet 57A connected to a conduit 58 that reaches proximate a bottom of the reservoir 12 to be submerged by the fluid. The mixing rod 57 has a second inlet 57B in fluid flow communication with the interior of the reservoir 12, but above the fluid for receiving air contained in the reservoir 12. The mixing rod 57 has an outlet connected to the inlet 50A of the valve 50. In use, when the user presses on the trigger 14 to release the mixture, the air pressure in the reservoir 12 pushes on the fluid thereby forcing the fluid to flow in the conduit 58 toward the nozzle 30. Simultaneously, air from the reservoir 12 and that sits above the fluid is forced through the second inlet 57B of the mixing rod 57 and mixes with the fluid thereby creating a foam. This foam is then directed toward the nozzle 30 via a conduit 59.

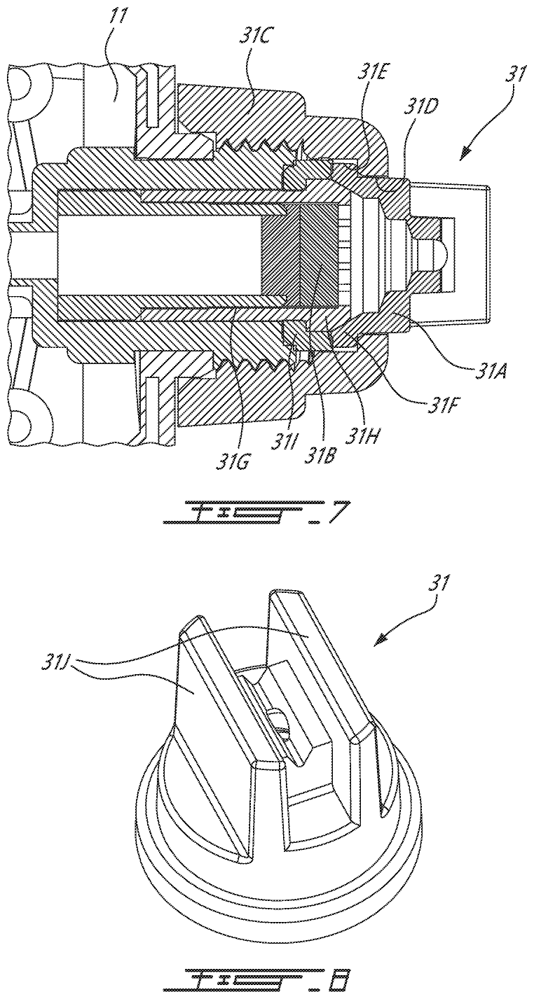

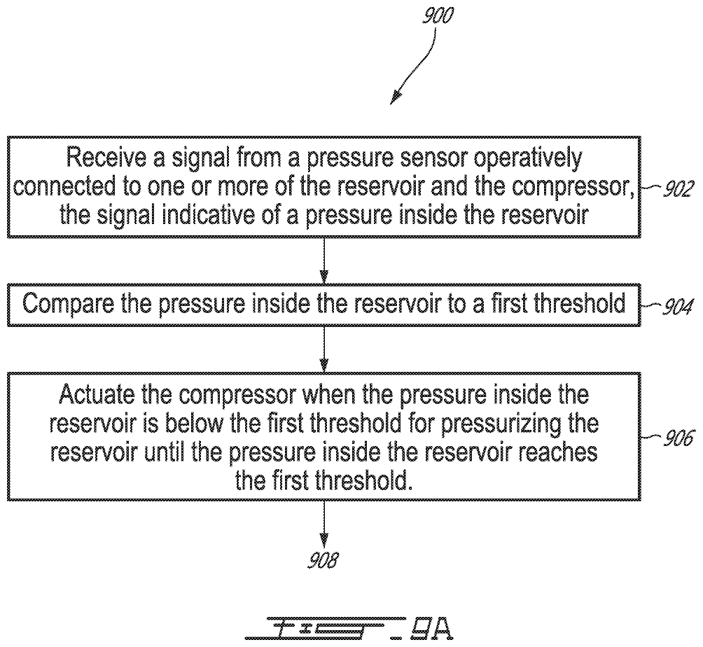

Referring to FIGS. 7-8, the tip 31 of the nozzle 30 may be a foaming nozzle having a housing 31A enclosing a porous material 31B. As shown in FIG. 8, the tip 31 includes two side walls 31J disposed on opposite sides of an outlet of the tip 31. The two side walls 31J are used to guide the foam during spraying. The porous material 31B may be a mesh, foam, fabric, plastic, cotton, filters, etc. Any suitable porous material may be used. The porous material defines a plurality of porosities interconnected with each other via tortuous flow path. When the mixture of air and fluid passes through the porous material 31B, it creates a thicker foam outputted by the nozzle 30. In the embodiment shown, a threaded connector 31C is threadingly engageable to the outer shell 11 of the foam sprayer 10. The threaded connector 31C defines a central aperture 31D circumscribed by a shoulder 31E. The shoulder 31E is in abutment against a flange 31F of the tip 31 to retain the tip 31 engaged to the outer shell 11 via the threaded connector 31C. The other tips 32, 33 also define a flange to be abutted by the shoulder 31E of the threaded connector 31C.

In the present embodiment, the porous material 31B is contained within a sleeve 31G received within a conduit defined by the outer shell 11. The sleeve 31G has a portion 31H sandwiched between the tip 31 and a retaining ring 311. The retaining ring 311 is in abutment against the flange 31F, which is itself sandwiched between the retaining ring 311 and the flange shoulder 31E.

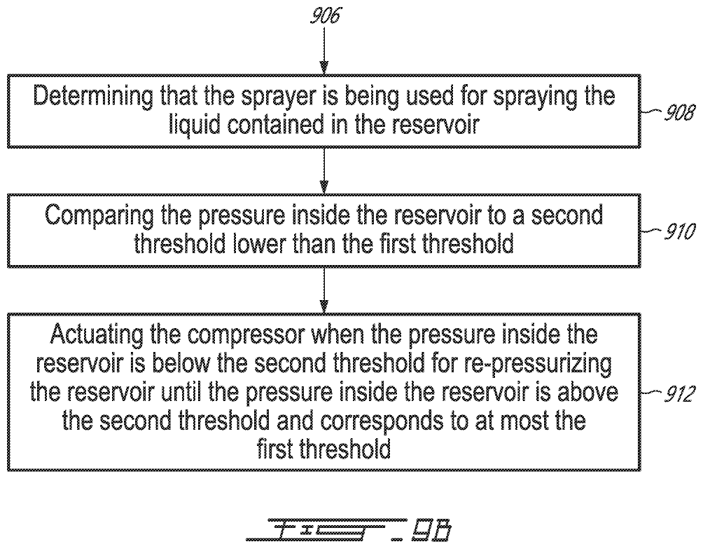

Referring now to FIG. 9A, a method of operating the foam sprayer 10 is shown at 900. The method 900 includes receiving a signal from the pressure sensor 22 operatively connected to one or more of the reservoir 12 and the compressor 40, the signal indicative of a pressure inside the reservoir 12 at step 902. The method 900 further includes comparing the pressure inside the reservoir 12 to a first threshold at step 904 and actuating the compressor 40 when the pressure inside the reservoir 12 is below the first threshold for pressurizing the reservoir 12 until the pressure inside the reservoir 12 reaches the first threshold at step 906.

Referring now to FIG. 9B, in the embodiment shown, the method 900 further includes determining at step 908 that the sprayer 10 is being used for spraying the liquid contained in the reservoir 12. The pressure inside the reservoir 12 is then compared to a second threshold lower than the first threshold at step 910 and the compressor 40 is actuated at step 912 when the pressure inside the reservoir 12 is below the second threshold for re-pressurizing the reservoir 12. At step 912, the compressor 40 is actuated until the pressure inside the reservoir is above the second threshold and corresponds to at most the first threshold. In some embodiments, the actuating of the compressor 40 for re-pressurizing the reservoir at step 912 includes actuating the compressor 40 until the pressure reaches the first threshold. Thus, when the user is spraying the foam, the compressor 40 may not be constantly operational. The pressure inside the reservoir 12 will gradually decrease as the liquid is being sprayed out of the reservoir 12 until the pressure reaches the second threshold. At this point, the compressor 40 will be powered on by the controller 100 for re-pressurizing the reservoir 12 until the pressure inside the reservoir 12 reaches the first threshold again. In other words, the compressor 40 may be intermittently operational as the foam is being sprayed. In some other embodiments, the actuating of the compressor 40 for re-pressurizing the reservoir 12 may be time-dependent. In other words, once the user starts spraying the foam, the controller 100 can actuate the compressor 40 when it determines that a given time period of spraying has lapsed.

In the depicted embodiment, the trigger 14 has a first configuration in which fluid communication between the reservoir 12 and an environment outside the reservoir 12 is blocked by the valve 50 and a second configuration in which the reservoir 12 is open to the environment for outputting the liquid. The determining that the sprayer 10 is being used (step 908) may include determining that the trigger 14 is in the second configuration. In some other embodiments, the determining that the sprayer 10 is being used (step 908) may include determining that the pressure inside the reservoir 12 is decreasing. This may be achieved by receiving a signal from the sensor 22, the signal being indicative of a decreasing pressure inside the reservoir 12. In other embodiments, a sensor (not shown) may be operatively connected to the trigger 14 to signal to the controller 100 that the foam is being sprayed.

In the present embodiment, the sprayer 10 may be configured for outputting a first indication of the compressor 40 being operational, and for outputting a second indication when the pressure inside the reservoir 12 reaches the first threshold. In the present case, this may be achieved via the indicator 20B that may emit a solid light when the pressure is at the first threshold and a blinking light when the compressor 40 is operational. In some other embodiments, a haptic and/or audible signal may be emitted by the sprayer 10 to notify the user of the compressor 40 being operational. Any other suitable means of providing an indication to the user may apply.

Referring now to FIG. 10, the controller 100 is shown in greater detail. The controller 100 is operatively connected to the sensor 22 and to the control panel 20. The control panel 20 may include an on-off button 20A for powering on or off the foam sprayer 10. When powered on, the foam sprayer 10 may start determining the pressure inside the reservoir 12 and actuating the pump 42 if the pressure is below a given threshold as will be discussed further below. The control panel 20 may further include an indicator 20B (e.g., light) indicative that the foam sprayer 10 is in a pressurizing phase in which the pump 42 is actuated for increasing the pressure inside the reservoir 12. The indicator 20B may be used to notify the user that the pressure inside the reservoir 12 reached its nominal value and that the foam sprayer 10 is ready to be used. In one embodiment, the indicator 20B may blink when the reservoir 12 is being pressurized. Once the pressure reaches the given threshold, the indicator 20B may stop blinking and remain on to notify the user that the sprayer 10 is ready to be used. Any suitable indicators may be used without departing from the scope of the present disclosure. In some embodiments, it is not necessary to provide any indication for proper operation.

In use, the controller 100 is configured for receiving a signal from the sensor 22, the signal indicative of a pressure inside the reservoir 12 or at the outlet of the pump 42 and for actuating the pump 42 with the motor 41 for increasing the pressure inside the reservoir 12 with the pump 42 until the pressure reaches a first threshold. In the embodiment shown, the controller 100 may be further configured for monitoring the pressure inside the reservoir 12; determining that the pressure is below a second threshold lower than the first threshold; and actuating the pump 42 with the motor 41 for increasing the pressure until the pressure is above the second threshold. The increasing of the pressure may be done until the pressure reaches the first threshold. The first threshold may be between 35 and 55 PSI, preferably about 45 PSI. When the pump 42 is actuated, the indicator 20B may be powered on. The second threshold may range from 10 to 30 PSI. The second threshold is preferably about 30 PSI. The expression “about” includes variations of plus or minus 10% in the context of the present disclosure.

In some embodiments, the controller 100 may be further configured for determining that the trigger 14 is actuated. The monitoring of the pressure inside the reservoir 12 may occur when the trigger 14 is actuated. In some other embodiments, the controller 100 may monitor the pressure inside the reservoir 12 with the sensor 22 as soon as the foam sprayer 10 is turned on with the on-off button 20A. In some embodiments, the controller 100 may receive a signal indicative of the trigger 14 being engaged by the user. The compressor 40 may be actuated based on a time function. In other words, the controller 100 may actuate the compressor 40 when it determines that the trigger 14 has been engaged for a predetermined amount of time (e.g., 1 minute).

The disclosed foam sprayer 10 may remove the need to manually pump a reservoir filled with soap/detergent to generate pressure and release quality foam. It may be a completely portable foaming solution. The sprayer 10 may be easy to operate, does not require a manual pump, may provide a consistent pressure output, may use universal battery, and may produce a quality foam. The interchangeable tips 31, 32, 33 may give the user a variety of spray pattern (e.g., narrow, wide, etc). The sprayer 10 may cost less than an attachment for a pressure washer and may achieve similar results.

With reference to FIG. 10, an example of a computing device 500 is illustrated. For simplicity only one computing device 500 is shown but more computing devices 500 operable to exchange data may be included. The computing devices 500 may be the same or different types of devices. The controller 100 may be implemented with one or more computing devices 500.

The computing device 500 comprises a processing unit 502 and a memory 504 which has stored therein computer-executable instructions 506. The processing unit 502 may comprise any suitable devices configured to implement the method of pressurizing the reservoir 12 such that instructions 506, when executed by the computing device 500 or other programmable apparatus, may cause the functions/acts/steps performed as part of the method of pressurizing the reservoir 12 as described herein to be executed. The processing unit 502 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 504 may comprise any suitable known or other machine-readable storage medium. The memory 504 may comprise non-transitory computer readable storage medium, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 504 may comprise any storage means (e.g., devices) suitable for retrievably storing machine-readable instructions 506 executable by processing unit 502.

The methods and systems of pressurizing the reservoir 12 described herein may be implemented in a high level procedural or object oriented programming or scripting language, or a combination thereof, to communicate with or assist in the operation of a computer system, for example the computing device 500. Alternatively, the methods and systems of pressurizing the reservoir 12 may be implemented in assembly or machine language. The language may be a compiled or interpreted language. Program code for implementing the methods and systems of pressurizing the reservoir 12 may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems of pressurizing the reservoir 12 may also be considered to be implemented by way of a non-transitory computer-readable storage medium having a computer program stored thereon. The computer program may comprise computer-readable instructions which cause a computer, or more specifically the processing unit 502 of the computing device 500, to operate in a specific and predefined manner to perform the functions described herein, for example those described in the method 400.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein may be implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

As can be seen therefore, the examples described above and illustrated are intended to be exemplary only. The scope is indicated by the appended claims.

What is claimed is:

1. A sprayer comprising:
a reservoir for containing a liquid to be sprayed;
a compressor fluidly connected to the reservoir;
a pressure sensor operatively connected to one or more of the compressor and the reservoir; and
a controller operatively connected to the compressor and the pressure sensor, the controller comprising a processing unit and a computer-readable medium having instructions stored thereon executable by the processing unit for:
receiving a signal from the pressure sensor, the signal indicative of a pressure inside the reservoir;
comparing the pressure inside the reservoir to a first threshold; and
when the pressure inside the reservoir is below the first threshold, actuating the compressor for pressurizing the reservoir until the pressure inside the reservoir reaches the first threshold.

2. The sprayer of claim 1, wherein the instructions are executable for:
determining that the liquid is being sprayed;
comparing the pressure inside the reservoir to a second threshold lower than the first threshold; and
when the pressure inside the reservoir is below the second threshold, actuating the compressor for re-pressurizing the reservoir until the pressure inside the reservoir is above the second threshold and corresponds to at most the first threshold.

3. The sprayer of claim 2, wherein the instructions are executable for actuating of the compressor for re-pressurizing the reservoir comprising actuating the compressor until the pressure inside the reservoir reaches the first threshold.

4. The sprayer of claim 2, comprising a trigger engaged to a valve selectively opening and closing a reservoir outlet of the reservoir, the trigger having a first configuration in which fluid communication between the reservoir and an environment outside the reservoir is blocked by the valve and a second configuration in which the reservoir is open to the environment for outputting the liquid, wherein the instructions are executable for determining that the liquid is being sprayed comprising determining that the trigger is in the second configuration.

5. The sprayer of claim 2, wherein the instructions are executable for determining that the liquid is being sprayed comprising determining that the pressure inside the reservoir is decreasing.

6. The sprayer of claim 1, comprising a connector having a connector inlet fluidly connected to an outlet of a pump of the compressor, a first connector outlet fluidly connected to the pressure sensor, and a second connector outlet fluidly connected to the reservoir.

7. The sprayer of claim 1, comprising:
a conduit having a first end for outputting the liquid and a second end configured to be submerged in the liquid; and
a mixer at the first end of the conduit, the mixer having a first mixer inlet fluidly connected to the first end of the conduit, a second mixer inlet in fluid flow communication with a volume of air inside the reservoir, and a mixer outlet for outputting a mixture of the air and the liquid from the reservoir.

8. The sprayer of claim 1, comprising a battery operatively connected to the compressor.

9. The sprayer of claim 1, comprising a control panel having:
a button operable to switch the sprayer between an off configuration and an on configuration; and
an indicator configured for outputting a first indication of the compressor being operational and for outputting a second indication when the pressure inside the reservoir reaches the first threshold.

10. The sprayer of claim 1, wherein the compressor includes a piston pump.

11. The sprayer of claim 1, wherein the reservoir is removably engageable to a body of the sprayer.

12. A method of operating a sprayer having a reservoir for containing a liquid to be sprayed and a compressor for pressurizing the reservoir, the method comprising:
receiving a signal from a pressure sensor operatively connected to one or more of the reservoir and the compressor, the signal indicative of a pressure inside the reservoir;
comparing the pressure inside the reservoir to a first threshold; and
when the pressure inside the reservoir is below the first threshold, actuating the compressor for pressurizing the reservoir until the pressure inside the reservoir reaches the first threshold.

13. The method of claim 12, further comprising:
determining that the sprayer is being used for spraying the liquid contained in the reservoir;
comparing the pressure inside the reservoir to a second threshold lower than the first threshold; and
when the pressure inside the reservoir is below the second threshold, actuating the compressor for re-pressurizing the reservoir until the pressure inside the reservoir is above the second threshold and corresponds to at most the first threshold.

14. The method of claim 13, wherein the actuating of the compressor for re-pressurizing the reservoir includes actuating the compressor until the pressure reaches inside the reservoir the first threshold.

15. The method of claim 13, wherein the sprayer comprises a trigger engaged to a valve selectively opening and closing a reservoir outlet of the reservoir, the trigger having a first configuration in which fluid communication between the reservoir and an environment outside the reservoir is blocked by the valve and a second configuration in which the reservoir is open to the environment for outputting the liquid, further wherein the determining that the sprayer is being used includes determining that the trigger is in the second configuration.

16. The method of claim 13, wherein the determining that the sprayer is being used includes determining that the pressure inside the reservoir is decreasing.

17. The method of claim 12, further comprising:
outputting a first indication of the compressor being operational; and
outputting a second indication when the pressure inside the reservoir reaches the first threshold.
